(19) United States
(12) Patent Application Publication
(10) Pub. No.: US 2026/0299598 A1
(43) Pub. Date: Oct. 1, 2026

(54) SYSTEMS AND METHODS FOR TRACKING A DYNAMIC OBJECT BY A ROBOT

(71) Applicant: COLLABORATIVE ROBOTICS, Santa Clara, CA (US)

(72) Inventors: Michael Lammers, Santa Clara, CA (US); Brandon Porter, Santa Clara, CA (US); Siddharth Gupta, Santa Clara, CA (US)

(21) Appl. No.: 19/633,796

(22) Filed: Mar. 30, 2026

Related U.S. Application Data
(60) Provisional application No. 63/781,157, filed on Mar. 31, 2025.

(51) Int. Cl. G05D 1/633; G05D 101/00; G05D 101/20

(52) U.S. Cl. CPC G05D 1/633; G05B 2219/39001; G05B 2219/42337; G05D 2101/20; G05D 2101/22

(57) ABSTRACT

A computing device for use in a robot may include computer readable media configured to store instructions and a processor configured to execute the instructions to cause or direct the computing device to perform operations. The operations may include obtaining tracking data representative of objects detected by a sensor or another robot. The operations may include detecting a dynamic object using object detection on the tracking data. The operations may include determining the dynamic object is no longer detected using object detection. The operations may include identifying an obstruction in the environment using object detection on the tracking data. The operations may include identifying a potential action of the dynamic object based on the obstruction and aspects of the dynamic object. The operations may include updating instructions of the robot based on the potential action to cause the robot to perform tasks in consideration of the dynamic object.

### CROSS-REFERENCE TO RELATED APPLICATION

This patent application claims the benefit of and priority to U.S. Provisional App. No. 63/781,157 filed Mar. 31, 2025 titled “SYSTEMS AND METHODS FOR TRACKING A DYNAMIC OBJECT BY A ROBOT,” which is incorporated in the present disclosure by reference in their entirety.

### FIELD

The embodiments discussed in the present disclosure are related to systems and methods for tracking a dynamic object by a robot.

### BACKGROUND

Unless otherwise indicated in the present disclosure, the materials described in the present disclosure are not prior art to the claims in the present application and are not admitted to be prior art by inclusion in this section.

Robots have been used in recent years to perform tasks in various facilities including manufacturing, warehouses, logistics, and delivery settings. Robotics has been useful in making tasks more efficient, thereby improving efficiency and lowering costs to operate the facilities.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One or more embodiments of the present disclosure may include a computing device for use in a robot. The computing device may include one or more computer readable media configured to store instructions. The computing device may also include a processor coupled to the computer readable media. The processor may be configured to execute the instructions to cause or direct the computing device to perform operations. The operations may include obtaining tracking data representative of objects detected by a sensor or another robot within an environment. The tracking data may be obtained from a cloud computing system. The operations may also include detecting a dynamic object in the environment using object detection on the tracking data. In addition, the operations may include determining the dynamic object is no longer detected using object detection on the tracking data. Further, the operations may include identifying an obstruction in the environment using object detection on the tracking data. The operations may include identifying a potential action of the dynamic object based on the obstruction and aspects of the dynamic object. The operations may also include updating instructions of the robot based on the potential action to cause the robot to perform tasks in consideration of the dynamic object to prevent the robot from colliding with the dynamic object or to cause the robot to assist the dynamic object complete a task.

One or more embodiments of the present disclosure may include a computing device for use in a robot. The computing device may include one or more computer readable media configured to store instructions. The computing device may also include a processor coupled to the computer readable media. The processor may be configured to execute the instructions to cause or direct the computing device to perform operations. The operations may include obtaining sensor data representative of an environment. The operations may also include identifying a dynamic object and a robot within the environment based on the sensor data. In addition, the operations may include determining locations of the dynamic object and the robot in the environment. Further, the operations may include determining the dynamic object is hidden from view of the robot based on the locations of the dynamic object and the robot. Further, the operations may include generating tracking data indicating that the dynamic object is hidden from the view of the robot and that the robot is to update instructions based on the dynamic object being hidden from the view of the robot.

One or more embodiments of the present disclosure may include a computing device for use in a robot. The computing device may include one or more computer readable media configured to store instructions. The computing device may also include a processor coupled to the computer readable media. The processor may be configured to execute the instructions to cause or direct the computing device to perform operations. The operations may include obtaining sensor data representative of an environment. The operations may also include determining whether a robot is within the environment. In addition, the operations may include responsive to the robot being detected within the environment, determining a confidence score that a dynamic object is within the environment based on the sensor data. Further, the operations may include generating tracking data indicating the confidence score and that the robot is to update instructions based on the confidence score.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates a block diagram of an example operational environment in which a robot may operate;

FIG. 2 illustrates a block diagram of an example operational environment in which the robot may operate

FIG. 3 illustrates a block diagram of an example operational environment in which the robot may operate;

FIG. 4 illustrates a block diagram of another example operational environment in which the robot may operate

FIG. 5 illustrates a block diagram of an example operational environment in which robots may operate;

FIG. 6 illustrates an example computing system that may be used to track dynamic objects by a robot, all according to at least one embodiment described in the present disclosure.

### DETAILED DESCRIPTION

A robot may perform various tasks in accordance with instructions stored in the robot. For example, the instructions may cause the robot to autonomously perform various tasks. As another example, the instructions may cause the robot to move within an environment. The instructions may cause the robot to perform the various tasks based on known details of the environment. However, the robot may operate in conjunction with or proximate to dynamic objects that move. Additionally or alternatively, the robot may move within the environment. The robot may implement a tracking algorithm to track objects (e.g., dynamic objects, static objects, or both) within the environment.

The robot, the dynamic objects, or both may move such that the dynamic objects are at least partially hidden (e.g., occluded) from view of the robot. For example, obstructions may be positioned between the robot and the dynamic objects. Some tracking algorithms only track objects when they are within the view of the robot. These tracking algorithms may not track objects when they are hidden from the view of the robot.

The tracking algorithms may cause the robot to look at and react to the environment at independent moments in time and not to perform tasks in consideration of hidden objects. Accordingly, the robot may perform the tasks without updating the instructions in consideration of the hidden objects. In other words, the robot may perform the tasks without considering the location, potential actions, or aspects of the dynamic objects when they are hidden. For example, the robot may drive around the obstructions until the robot can see the dynamic object, which may not be until the robot collides with the dynamic objects or is closer than a minimum safety distance that the robot is supposed to maintain.

Therefore, there is a need for the robot to be able to remember (e.g., track) dynamic objects when they are hidden from the view of the robot and update the instructions so that the robot performs the tasks in consideration of the dynamic objects.

The present disclosure provides techniques for avoiding or reducing the technical difficulties described above. Some embodiments described in the present disclosure include a computing device that tracks dynamic objects even when occluded from view of the robot. The computing device may remember the dynamic objects when they are hidden from the view of the robot. The computing device may update the instructions to cause the robot to operate in consideration of the dynamic objects. In addition, the computing device may implement a tracking algorithm to prevent the dynamic objects from seeming to disappear when the dynamic objects are hidden from the view of the robot. The computing device may be located on or within the robot. Alternatively, the computing device may include a cloud computing system that is located remote from the robot.

The computing device may capture tracking data representative of objects within the environment including the dynamic objects and the static objects. The computing device may obtain the tracking data via one or more sensors of the robot or within the environment. Additionally or alternatively, the computing device may obtain the tracking data from a data storage, the cloud computing system, or some combination thereof.

The robot may use the tracking data to track the dynamic objects. The computing device may determine the dynamic object is hidden (e.g., occluded) from view of the robot based on the tracking data. For example, the computing device may identify a potential action of the dynamic object, while hidden, based on the tracking data.

The computing device may use the tracking data to perform tasks in consideration of the dynamic objects. For example, the computing device may identify routes to traverse to cause the robot to avoid the dynamic objects. As another example, the computing device may update the instructions based on the potential action of the dynamic object to cause the robot to perform the tasks in consideration of the dynamic object.

As described in more detail below, the embodiments of the present disclosure may allow the robot to operate in consideration of dynamic objects even when the dynamic objects are occluded or hidden from a direct view of the robot.

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

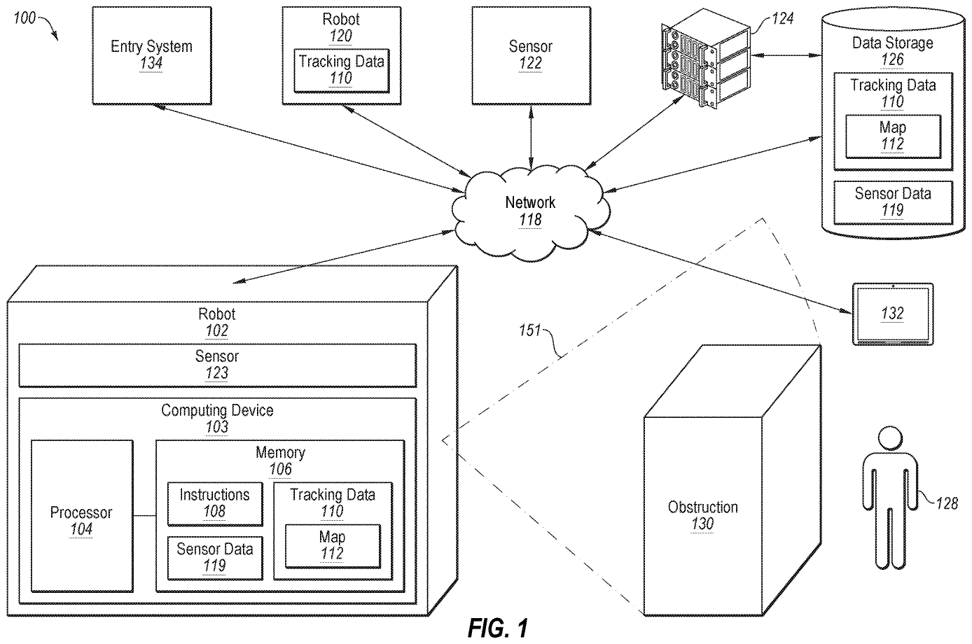

FIG. 1 illustrates a block diagram of an example operational environment 100 in which a robot 102 may operate, in accordance with at least one embodiment described in the present disclosure. The environment 100 may include any location in which the robot 102 may operate. For example, the environment 100 may include a warehouse, a hospital, a campus, a building, a field, a construction site, and the like. The robot 102 may include an autonomous robot or any other appropriate type of robot configured to perform operations within the environment 100.

The robot 102 may perform various tasks within the environment 100 in accordance with instructions 108 stored in the memory 106. For example, the instructions 108 may cause the robot 102 to autonomously perform various tasks within the environment 100. As another example, the instructions 108 may cause the robot 102 to navigate the environment 100 to avoid objects (e.g., a dynamic object 128), interact with objects (e.g., receive a load from the dynamic object 128), or both.

The robot 102 may perform the tasks based on actions of and/or in proximity to the dynamic object 128, a static object (e.g., the obstruction 130), or any combination thereof. The obstruction 130 is discussed herein as being a static object for example purposes but could include another dynamic object. The robot 102 may include a sensor 123 (e.g., an onboard sensor or computer vision system) configured to capture tracking data representative of the environment 100 including the dynamic object 128. The robot 102 may use the tracking data 110 to track the dynamic object 128 (e.g., movement and/or location of the dynamic object 128). Further, the robot 102 may use the tracking data 110 to identify a route to traverse or areas to avoid the dynamic object 128.

The dynamic object 128 may include any type of mobile object that can move. The dynamic object 128 is illustrated in FIG. 1 as a human for example purposes. However, the dynamic object 128 may include any appropriate mobile object. Examples of the dynamic object 128 include a human, a mobile cart, another robot, an object being pushed by a human or a robot, an animal, or any other appropriate mobile object.

The robot 102, the dynamic object 128, or both may move such that the dynamic object 128 is at least partially hidden (e.g., occluded) from a field of view 151 of the robot 102. As shown in FIG. 1, the obstruction 130 is positioned between the robot 102 and the dynamic object 128 preventing the robot 102 from detecting/seeing the dynamic object 128. For example, the obstruction 130 may include a shelf and the dynamic object 128 may move behind the shelf 130 relative to the robot 102 and become hidden from the field of view 151 of the robot 102.

The computing device 103 or a cloud computing system 124 may be configured to remember the dynamic object 128 when it is hidden from the field of view 151 of the robot 102. The computing device 103 or the cloud computing system 124 may update the instructions 108 to cause the robot 102 to operate in consideration of the dynamic object 128. In addition, the computing device 103 or the cloud computing system 124 may implement a tracking algorithm to prevent the dynamic object 128 from seeming to disappear when the dynamic object 128 is hidden from the field of view 151 of the robot 102.

The computing device 103 or the cloud computing system 124 may obtain the tracking data 110. The tracking data 110 may be obtained via the sensor 123, a sensor 122 within the environment 100, a data storage 126, the cloud computing system 124, or some combination thereof. In addition, the computing device 103 or the cloud computing system 124 may determine the dynamic object 128 is hidden (e.g., occluded) from view of the robot 102 based on the tracking data 110. Further, the computing device 103 or the cloud computing system 124 may identify a potential action of the dynamic object 128, while hidden, based on the tracking data 110. The computing device 103 or the cloud computing system 124 may update the instructions 108 based on the potential action of the dynamic object 128 to cause the robot 102 to perform the tasks in consideration of the dynamic object 128 even though it is hidden from the field of view 151 of the robot 102.

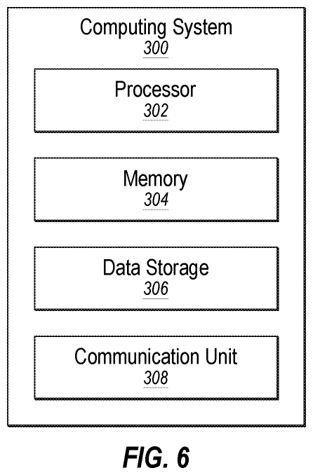

The computing device 103 may include a desktop computer, a laptop computer, a smartphone, a mobile phone, a tablet computer, a server, a processing system, or any other computing system or set of computing systems that may be used for performing the operations described in this disclosure. An example of such a computing system is described below with reference to FIG. 6. The computing device 103 may include a processor 104 and a memory 106.

The cloud computing system 124 may be a computer system that provides services to the computing device 103 over a network 118. The cloud computing system 124 may include hardware components such as a processor and a storage medium. An example of such a computing system is described below with reference to FIG. 6.

The processor 104 may include a central processing unit (CPU), a microprocessor (μP), a microcontroller (μC), a digital signal processor (DSP), a field-programmable gate array (FPGA), an application-specific integrated circuit (ASIC), or any combination thereof. The processor 104 may be configured to execute computer instructions that, when executed, cause the processor 104 or the computing device 103, to perform or control performance of one or more of the operations described herein with respect to operation of the robot 102. The processor 104 may be implemented using a combination of hardware and software. In the present disclosure, operations described as being performed by the processor 104 or the computing device 103 may include operations that the processor 104 or the computing device 103 directs a corresponding system to perform.

The memory 106 may include a storage medium such as a RAM, persistent or non-volatile storage such as ROM, EEPROM, CD-ROM, or other optical disk storage, magnetic disk storage or other magnetic storage device, NAND flash memory or other solid state storage device, or other persistent or non-volatile computer storage medium. The memory 106 may store computer instructions that may be executed by the processor 104 or the computing device 103 to perform or control performance of one or more of the operations described herein with respect to operation of the robot 102. In addition, the memory 106 may store the instructions 108, the tracking data 110, and/or the map 112 persistently and/or at least temporarily.

The data storage 126 may include any memory or data storage. The data storage 126 may include network communication capabilities such that other components in the environment 100 may communicate with the data storage 126. For example, the computing device 103 may obtain the tracking data 110 or any other appropriate data from the data storage 126. In some embodiments, the data storage 126 may include computer-readable storage media for carrying or having computer-executable instructions or data structures stored thereon. The computer-readable storage media may include any available media that may be accessed by a general-purpose or special-purpose computer, such as a processor. For example, the data storage 126 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the data storage 126.

The environment 100 may include the network 118 that includes any communication network configured for communication of signals between any of the components (e.g., 102, 120, 122, 124, 126, 132, or 134) of the environment 100. The network 118 may be wired or wireless. The network 118 may have numerous configurations including a star configuration, a token ring configuration, or another suitable configuration. Furthermore, the network 118 may include a local area network (LAN), a wide area network (WAN) (e.g., the Internet), and/or other interconnected data paths across which multiple devices may communicate. In some embodiments, the network 118 may include a peer-to-peer network. The network 118 may also be coupled to or include portions of a telecommunications network that may enable communication of data in a variety of different communication protocols.

In some embodiments, the network 118 includes or is configured to include a BLUETOOTH® communication network, a Z-Wave® communication network, an Insteon® communication network, an EnOcean® communication network, a wireless fidelity (Wi-Fi) communication network, a ZigBee communication network, a HomePlug communication network, a Power-line Communication (PLC) communication network, a message queue telemetry transport (MQTT) communication network, a MQTT-sensor (MQTT-S) communication network, a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 118 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, or any other protocol that may be implemented with the components (e.g., 102, 120, 122, 124, 126, 132, or 134) of the environment 100.

The sensors 122, 123 may capture the sensor data 119 representative of at least part of the environment 100. In FIG. 1, a single instance of the sensor 122 is illustrated for example purposes. However, the environment 100 may include any appropriate number or instances of the sensor 122. In addition, a single instance of the sensor 123 is positioned on the robot 102 for example purposes. However, the robot 102 may include any appropriate number or instances of the sensor 123.

The sensors 122, 123 may include cameras and/or video cameras configured to capture image data or video data representative of the environment 100. The cameras and/or the video cameras may be positioned at various points in the environment 100 and/or the robot 102 to provide a wide field of view for the sensors 122, 123. Additionally or alternatively, the sensors 122, 123 may include microphones or other audio control interfaces configured to capture audio data representative of the environment 100. Examples of the sensors 122, 123 include cameras (e.g., a fixed camera), video cameras, Light Detection and Ranging (LiDAR) devices, radar devices, infrared devices, global positioning service (GPS) devices, other devices configured to capture images, or any other appropriate sensor data.

The sensors 122, 123 may include occupancy sensors to detect the presence of humans (e.g., the dynamic object 128) within specific areas of the environment 100. The occupancy sensors may include an infrared sensor, an ultrasonic sensor, or a motion detection sensor.

The environment 100 may also include an additional robot 120 that includes sensors (not shown) that are configured to capture the sensor data 119.

Operations of the computing device 103 to track the dynamic object 128 will now be discussed. The computing device 103, responsive to the robot 102 entering the environment 100 or a particular area of the environment 100, may query the cloud computing system 124, the other robot 120, or both for a likelihood of the dynamic object 128 being in the environment 100 or in the particular area of the environment 100. The computing device 103 may query the cloud computing system 124, the data storage 126, the other robot 120, or some combination thereof for the tracking data 110 when entering the environment 100 or the particular area of the environment 100. The cloud computing system 124, the other robot 120, the data storage 126, or some combination thereof may send (e.g., transmit) the tracking data automatically to the robot 102 when it enters the environment 100 or the particular area of the environment 100.

The computing device 103 may obtain the tracking data 110 to determine the presence of the dynamic object 128 in the environment 100 or any other appropriate feature of the dynamic object 128. The tracking data 110 may indicate that the dynamic object 128 is hidden from the field of view 151 of the robot 102 (e.g., the tracking data 110 may include a specific marker indicating the obstruction 130 is positioned between the robot 102 and the dynamic object 128), a confidence score of particular features of the dynamic object 128, a potential action of the dynamic object 128, or some combination thereof. Each of these pieces of information is discussed in more detail below.

The tracking data 110 may include object data representative of the dynamic object 128 or other objects in the environment 100 (e.g., the other robot 120, the obstruction 130, or both). For example, the object data may indicate motion/position (e.g., position, velocity, trajectory, acceleration, a direction the dynamic object 128 is facing, or any other appropriate data related to the motion/position of the dynamic object 128), object type, employee schedules, entry data, object status, historical occupancy data, or any other appropriate data related to objects in the environment 100.

The environment 100, as shown in FIG. 1, includes an entry system 134 (e.g., a badge scanner, a biometric scanner, or any other appropriate type of entry system) that is configured to generate the entry data. The entry data may indicate when the dynamic object 128 (e.g., a human) enters and/or exits the environment 100. Additionally or alternatively, the environment 100, as shown in FIG. 1, includes a user device 132 that is configured to generate the object status of the dynamic object 128. For example, the user device 132 may implement a messaging application that indicates whether the object status of the dynamic object 128 is set to away, available, or out of office. The user device 132 may include any appropriate computing system and may be the same as or similar to the computing device 103 and an example of such a computing system is described below with reference to FIG. 6.

The tracking data 110 may include environmental data representative of static features of the environment 100. For example, the environmental data may include building plans indicating the locations of walls, stairs, rooms, or any other appropriate static feature of the environment 100.

The computing device 103 may fuse or aggregate the sensor data 119 or the tracking data 110. In particular, the sensor data 119 may include different types of data (e.g., image data and audio data) and the computing device 103 may merge the different types of data to form the sensor data 119 as a unified dataset. The computing device 103 may fuse the object data, the environmental data, or the sensor data 119 to form the tracking data 110 as a unified dataset. For example, the computing device 103 may fuse or merge the sensor data 119 with the tracking data 110 received from the cloud computing system 124 or the data storage 126 such that the tracking data 110 stored in the memory 106 includes the object data, the environmental data, the sensor data, or some combination thereof.

The computing device 103 may identify the dynamic object 128 or other objects in the environment 100 based on the tracking data 110. The computing device 103 may implement object detection on the tracking data 110 to detect and classify the objects. For example, the computing device 103 may implement face detection on the tracking data 110 to classify the dynamic object 128 as a human and/or identify the human as a worker. As another example, the computing device 103 may implement object detection on the tracking data 110 to classify the dynamic object 128 as a cart. As yet another example, the computing device 103 may implement object detection on the tracking data 110 to classify the obstruction 130 as a static object. In addition, the computing device 103 may estimate a pose of the dynamic object 128.

The computing device 103 may implement object detection (e.g., computer vision techniques) to determine a location of the obstruction 130, the dynamic object 128, or both. For example, the dynamic object 128 may be positioned within the field of view 151 of the robot 102 at a point in time (a point in time different than what is shown in FIG. 1) and the computing device 103 may determine the location of the dynamic object 128 at that point in time.

The tracking data 110 may include a map 112 of the environment 100. The computing device 103 may generate and/or update the map 112 based on the tracking data 110. The map 112 may indicate locations of objects (dynamic locations of the dynamic object 128), typical locations of the dynamic object 128 (e.g., a heat map of historical locations of the dynamic object 128), likely locations the dynamic object 128 is to move based on a current location (e.g., a heat map of likely movements of the dynamic object 128), a direction the dynamic object 128 is facing, a trajectory of the dynamic object 128, a probabilistic layout of object locations within the environment 100, or any other appropriate information.

The computing device 103 may determine the dynamic object 128 is hidden from the field of view 151 of the robot 102 based on the tracking data 110. In particular, the tracking data 110 may continuously be captured/generated and the computing device 103 may persistently track movement of the dynamic object 128 within the field of view 151 of the robot 102 using the tracking data 110 (e.g., the map 112). Additionally or alternatively, the computing device 103 may identify the marker in the tracking data 110 indicating that the obstruction 130 is between the robot 102 and the dynamic object 128 (e.g., the marker indicating that the dynamic object 128 is hidden from the view of the robot 102).

The computing device 103 may implement one or more tracking algorithms to track the dynamic object 128, determine the dynamic object 128 is hidden from the field of view 151 of the robot 102, or both. For example, the computing device 103 may implement Naive tracking, simple online and realtime tracking (SORT), deepSORT, optical flow, feature matching, ByteTrack, or any other appropriate tracking algorithm.

The computing device 103 may detect the dynamic object 128, the obstruction 130, or both independently in each frame of the tracking data 110. In particular, the computing device 103 may detect the dynamic object 128 and/or the obstruction 130 in the environment 100 using object detection on a first frame of the tracking data 110 that includes the dynamic object 128. Additionally, the computing device 103 may determine the dynamic object 128 is no longer detected in the environment 100 using object detection on a second frame of the tracking data 110 that includes the obstruction 130 but does not include the dynamic object 128. Accordingly, the computing device 103 may determine that the dynamic object 128 is hidden by the obstruction 130.

The computing device 103 may implement Kalman filters, data association, and/or appearance feature detection on the tracking data 110. The computing device 103 may analyze pixel movement patterns across frames of the tracking data 110. Additionally or alternatively, the computing device 103 may identify object features like SIFT, ORB, or SURF across frames of the tracking data 110.

The computing device 103 may determine a confidence score to indicate a likelihood of the dynamic object 128 occupying an actual location or an expected location. For example, the confidence score may indicate the likelihood that the dynamic object 128 is occupying a location that is hidden from view of the robot 102 (e.g., is positioned behind the obstruction 130). In other words, the confidence score may indicate the likelihood that dynamic object 128 is occupying a location such that the obstruction 130 is positioned between the dynamic object 128 and the robot 102. As another example, the confidence score may indicate the likelihood that the dynamic object 128 is actually occupying a detected location. As yet another example, the confidence score may indicate a likelihood that the dynamic object 128 is occupying a location that is external to the environment 100 (e.g., the likelihood that the dynamic object 128 has left the environment 100). As yet another example, the confidence score may indicate a likelihood that the dynamic object 128 will move to and occupy various locations (e.g., expected locations) within the environment 100.

A higher confidence score may indicate a higher likelihood that the dynamic object 128 is at the actual location or will move to the expected location. A lower confidence score may indicate a lower likelihood that the dynamic object 128 is at the actual location or will move to the expected location. The confidence score may always be above zero (e.g., a likelihood above zero percent) unless the tracking data 110 confirms that the dynamic object 128 left the environment 100. The computing device 103 may determine that the dynamic object 128 is hidden from the field of view 151 of the robot 102 if the confidence score exceeds a threshold value. Additionally, the computing device 103 may determine that the dynamic object 128 is hidden from the field of view 151 of the robot 102 if the confidence score exceeds the threshold value and the dynamic object 128 is not currently detected.

The confidence score may impact a rate at which the robot 102 performs a task in at least part of the environment 100. For example, when the confidence score indicates a high likelihood that the dynamic object 128 is occupying a location behind the obstruction 130, the computing device 103 may adjust the instructions 108 to cause the robot 102 to reduce its speed proximate to the obstruction 130.

The computing device 103 may determine the confidence score based on at least one of an aspect of the dynamic object 128, a trajectory of the dynamic object 128, an amount of time since the dynamic object 128 was detected, or an expected behavior of the dynamic object 128. Example aspects of the dynamic object 128 may include whether the dynamic object 128 limited in its mobility, an age of the dynamic object 128 (e.g., is the dynamic object 128 a kid or an elder), is the dynamic object 128 connected to any additional equipment (e.g., a cart, medical devices, a wheelchair, or any other appropriate equipment). The trajectory of the dynamic object 128 may increase a likelihood that the dynamic object 128 is going to occupy a location along the trajectory and reduce a likelihood that the dynamic object 128 is going to occupy a location that is behind or next to the trajectory. The amount of time since the dynamic object 128 was detected may include an amount of time since the dynamic object 128 was initially detected in the environment 100, an amount of time since the dynamic object 128 was last detected in the environment 100, or both. The expected behavior of the dynamic object 128 may include expected actions to be taken by the dynamic object as discussed in more detail below.

The computing device 103 may learn expected behaviors or typical movement patterns of the dynamic object 128 based on historical data in the tracking data 110. For example, the computing device 103 may learn that the dynamic object 128 typically enters the environment 100 at a particular time and typically exits the environment at another particular time. As another example, the computing device 103 may learn that the dynamic object 128 typically goes to a first location (e.g., a nurse station) in the environment 100 after being at a second location (e.g., a supply closet). As yet another example, the computing device 103 may learn that the dynamic object 128 typically traverses a particular route. As yet another example, the computing device 103 may learn that the dynamic object 128 typically stays at a particular location for a specific period of time.

The computing device 103 may identify potential actions of the dynamic object 128 based on the tracking data 110, the confidence score, or both. The computing device 103 may identify the potential actions of the dynamic object 128 based on the expected behaviors of the dynamic object 128. For example, the computing device 103 may identify a potential action of the dynamic object 128 when it enters the environment 100 includes placing a load at a location, interacting with an object, or exiting the environment 100.

The computing device 103 may update the instructions 108 based on the potential action, the confidence score, or both. In particular, the computing device 103 may update the instructions to cause the robot 102 to perform the tasks in consideration of the dynamic object 128.

Causing the robot 102 to perform the tasks in consideration of the dynamic object 128 may include performing the tasks in a manner that reduces a likelihood of a collision between the robot 102 and the dynamic object 128, the dynamic object 128 getting closer than a minimum safety distance to the dynamic object 128, or any other appropriate consideration of the dynamic object 128.

The computing device 103 may update the instructions 108 to cause the robot 102 to avoid an area within the environment 100. For example, the computing device 103 may update the instructions 108 to cause the robot 102 to avoid an area because there is a higher likelihood of the dynamic object 128 occupying that location. As another example, the computing device 103 may update the instructions 108 to cause the robot 102 to avoid an area because there is a higher likelihood that the dynamic object 128 will move along a path that includes the area. In other words, the computing device 103 may update the instructions 108 to cause the robot 102 to navigate around the area. In particular, the computing device 103 may move waypoints of standard or common routes of the robot 102 to avoid the area (e.g., avoid a flow of people in a hallway).

The computing device 103 may update the instructions 108 to cause the robot 102 to ask to assist the dynamic object 128. For example, the computing device 103 may update the instructions 108 to cause the robot 102 to approach the dynamic object 128 and ask to take over a task for the dynamic object 128 (e.g., take over pushing a cart or putting items on a shelf).

The computing device 103 may update the instructions 108 to cause the robot 102 to scan the environment 100 for the dynamic object 128. The computing device 103 may update the instructions 108 to cause the robot 102 to ask the other robot 120 to scan the environment 100 for the dynamic object 128. Additionally or alternatively, the computing device 103 may update the instructions 108 to cause the robot 102 to ask the cloud computing system 124 to scan the environment 100 for the dynamic object 128.

For instance, the computing device 103 may determine that seven dynamic objects are expected in the environment 100 based on the tracking data 110 but the computing device 103 is currently detecting only five dynamic objects and cause the robot 102 to ask the other robot 120 and/or the cloud computing system 124 to scan the environment 100 to try and locate the other two dynamic objects. As another instance, the computing device 103 may determine that the dynamic object 128 is expected at a particular location and the computing device 103 may cause the robot 102 to ask the other robot 120 and/or the cloud computing system 124 to scan the environment 100 to try and detect the dynamic object 128 at the particular location.

Operations of the cloud computing system 124 to track the dynamic object 128 will now be discussed. The cloud computing system 124 may perform the same or similar operations as described above in relation to the computing device 103. The cloud computing system 124 may generate the tracking data 110 to include the confidence score, the marker, or any other information discussed above. The cloud computing system 124 may generate the tracking data 110 based on or to include the sensor data 119 and/or based on information from the user device 132, or the entry system 134.

The cloud computing system 124 may identify the dynamic object 128, the obstruction 130, or both based on the sensor data 119. For instance, the cloud computing system 124 may perform object detection on the sensor data 119, the tracking data 110, or both. The cloud computing system 124 may perform object detection in the same or a similar way as the discussed above in relation to the computing device 103 to determine a location of the obstruction 130 and/or the dynamic object 128.

The cloud computing system 124 may generate the map 112 based on the sensor data 119, the tracking data 110, or both. The cloud computing system 124 may determine the dynamic object 128 is hidden from the field of view 151 of the robot 102 based on the tracking data 110, the sensor data 119, or both. The cloud computing system 124 may persistently track movement of the dynamic object 128 within the environment 100 using the sensor data 119, the tracking data 110 (e.g., the map 112), or both.

The cloud computing system 124 may implement one or more tracking algorithms to track the dynamic object 128, determine the dynamic object 128 is hidden from the field of view 151 of the robot 102, or both. For example, the cloud computing system 124 may implement Naive tracking, SORT, deepSORT, optical flow, feature matching, ByteTrack, or any other appropriate tracking algorithm.

The cloud computing system 124 may determine the confidence score to indicate a likelihood of the dynamic object 128 occupying an actual location or an expected location. The cloud computing system 124 may determine the confidence score in the same or a similar manner as discussed above in relation to the computing device 103.

The cloud computing system 124 may learn expected behaviors or typical movement patterns of the dynamic object 128 based on historical data in the tracking data 110. For example, the cloud computing system 124 may learn that the dynamic object 128 typically enters the environment 100 at a particular time and typically exits the environment at another particular time. As another example, the cloud computing system 124 may learn that the dynamic object 128 typically goes to a first location (e.g., a nurse station) in the environment 100 after being at a second location (e.g., a supply closet). As yet another example, the cloud computing system 124 may learn that the dynamic object 128 typically traverses a particular route. As yet another example, the cloud computing system 124 may learn that the dynamic object 128 typically stays at a particular location for a specific period of time.

The cloud computing system 124 may identify potential actions of the dynamic object 128 based on the tracking data 110, the confidence score, or both. In some embodiments, the cloud computing system 124 may identify the potential actions of the dynamic object 128 based on the expected behaviors of the dynamic object 128. For example, the cloud computing system 124 may identify a potential action of the dynamic object 128 when it enters the environment 100 includes placing a load at a location, interacting with an object, or exiting the environment 100.

The cloud computing system 124 may generate the tracking data 110 indicating that the dynamic object is hidden from the field of view 151 of the robot 102. In addition, the tracking data 110 may indicate that the computing device 103 is to update the instructions 108 based on the dynamic object being hidden from the field of view 151 of the robot 102. Further, the cloud computing system 124 may transmit the tracking data 110 including the map 112 to the robot 102.

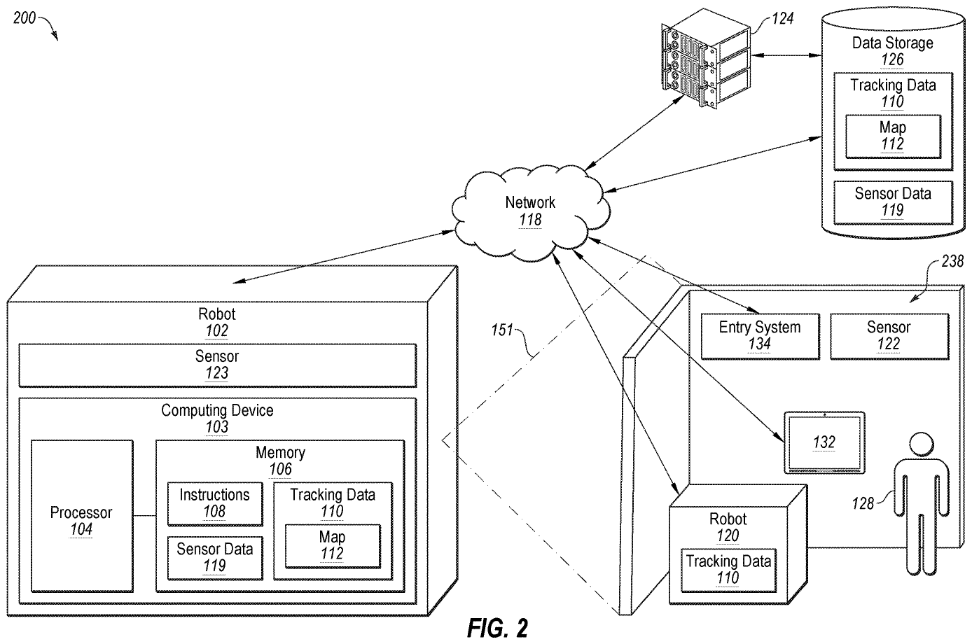

FIG. 2 illustrates a block diagram of an example operational environment 200 in which the robot 102 may operate, in accordance with at least one embodiment described in the present disclosure. The environment 200 may include any location in which the robot 102 may operate. For example, the environment 200 may include a warehouse, a hospital, a campus, a building, a field, a construction site, and the like.

As shown in FIG. 2, the environment 200 includes an area 238. The area 238 may represent a part of the environment 200 that is isolated from other parts of the environment 200 by walls or other structures. For example, the area 238 may represent a room or a hallway in the environment 200.

The area 238 may be hidden from the field of view 151 of the robot 102 (e.g., walls or other structures of the area 238 may hide the area 238 from the view of the robot 102) until the robot 102 enters the area 238. When the robot 102 enters the area 238 the robot 102 may not know whether the dynamic object 128 or any other objects are in the area 238. Accordingly, the robot 102 may not be able to perform the tasks in consideration of the objects 128 in the area 238.

Operations of the computing device 103 to request the tracking data 110 when entering the area 238 will now be discussed. The computing device 103 may obtain the tracking data 110 from the cloud computing system 124, the other robot 120, or both. The tracking data 110 may indicate whether the other robot 120 and/or the dynamic object 128 are located in the area 238. The robot 102 may enter the area 238 and the computing device 103 may determine whether the other robot 120 is within the area 238 based on the sensor data 119. The robot 102, responsive to the other robot 120 already being in the area 238, may ask the other robot 120 for the tracking data 110. In addition, the computing device 103 may determine the confidence score based on the tracking data 110. Accordingly, the computing device 103 may determine the likelihood of a new area in which the robot 102 enters including the dynamic object 128. Additionally or alternatively, the computing device 103 may update the instructions 108 based on the tracking data 110 when entering a new area.

Operations of the cloud computing system 124 to request the tracking data 110 when entering the area 238 will now be discussed. The cloud computing system 124 may obtain the sensor data 119 from the sensor 122 in the area 238 or the other robot 120. The sensor data 119 may be representative of the area 238. The cloud computing system 124 may determine whether the other robot 120 is within the area 238 based on the sensor data 119. The cloud computing system 124, responsive to the other robot 120 being detected within the area 238, may determine the confidence score indicating whether the dynamic object 128 is also within the area 238 based on the sensor data 119.

The cloud computing system 124 may send the tracking data 110 to the robot 102 when it approaches the area 238, enters the area 238, or at any other appropriate time. The computing device 103 may perform operations that are the same or similar to those discussed above to update the instructions 108 based on the tracking data 110 representative of the area 238.

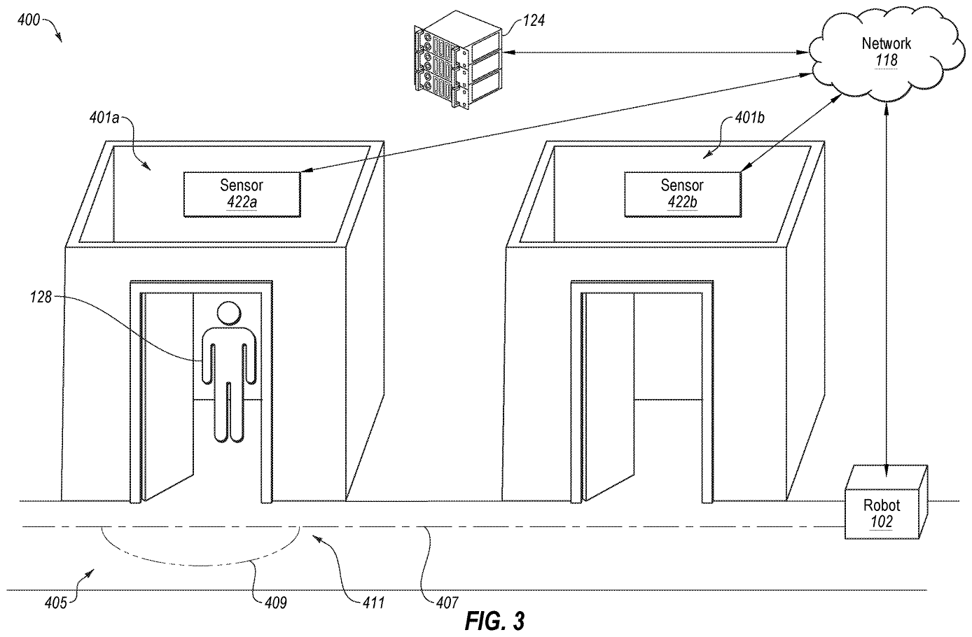

FIG. 3 illustrates a block diagram of an example operational environment 400 in which the robot 102 may operate, in accordance with at least one embodiment described in the present disclosure. The environment 400 may include any location in which the robot 102 may track the dynamic object 128. For example, the environment 400 may include a warehouse, a hospital, a campus, a building, a field, a construction site, and the like.

As shown in FIG. 3, the environment 400 includes the network 118, the dynamic object 128, the robot 102, sensors 422a-b, the cloud computing system 124, a first area 401a, and a second area 401b. The first area 401a and the second area 401b (generally referred to herein as the areas 401) may include different rooms within the environment 400. Additionally, the environment 400 may include a hallway 405 that connects the areas 401 and allows the robot 102 to access the different areas 401 (e.g., via different entryways). The sensors 422a-b may correspond to the sensor 122 of FIG. 1.

As shown in FIG. 3, the first area 401a includes the dynamic object 128 (e.g., the dynamic object 128 is located within the first area 401a) and the second area 401b does not include a dynamic object. The sensors 422a-b may include occupancy sensors and/or motion sensors configured to detect the presence of the dynamic object 128 (e.g., a human) within the corresponding areas 401. The sensors 422a-b may be strategically placed in the areas 401 to provide comprehensive coverage.

The sensors 422a-b may capture sensor data indicating an occupancy of the areas 401 (e.g., presence of the dynamic object 128). For example, the sensor data captured by the sensor 422a indicates that the dynamic object 128 (e.g., a human) is in the first area 401a and the sensor data captured by the sensor 422b indicates that no dynamic object is in the second area 401b.

The sensors 422a-b may transmit the sensor data to the robot 102, the cloud computing system 124, or both via the network 118. The cloud computing system 124, the robot 102, or both may determine occupancy levels of the areas 401 based on the sensor data. In addition, the cloud computing system 124, the robot 102, or both may update the instructions of the robot 102 to perform tasks in consideration of the occupancy of the areas 401. For example, the instructions of the robot 102 may be updated to perform tasks within the hallway 405 based on the occupancy (e.g., presence of the dynamic object 128) in the first area 401a because there is a probability of the dynamic object 128 exiting the first area 401a and entering the hallway 405.

As depicted in FIG. 3, the robot 102 traverses the hallway 405 along a path 411. The instructions of the robot 102 may initially cause the robot 102 to follow route 407, shown as a single dashed line, of the path 411. The route 407 may maintain equal distances from the entrances to the areas 401. However, upon the cloud computing system 124 and/or the robot 102 determining that the first area 401a is occupied, the instructions of the robot 102 may be updated to cause the robot 102 to traverse an adjusted route 409, shown as a double dashed line in FIG. 3, of the path 411. The adjusted route 409 may correspond to a portion of the path 411 that is proximate to the entrance to the first area 401a.

As shown in FIG. 3, the adjusted route 409 deviates from the route 407 when proximate to the entrance of the first area 401a to give the first area 401a a wider berth than the second area 401b. When the robot 102 is beyond the entrance to the first area 401a, the robot 102 may merge back onto the route 407. Accordingly, the robot 102 may perform the task of traversing the hallway 405 in consideration of the dynamic object 128 occupying the first area 401a but not occupying the second area 401b.

The example of the instructions of the robot 102 being modified to alter the path 411 is provided as illustrative. The instructions of the robot 102 may be modified to alter any appropriate task in consideration of the dynamic object 128. For example, the instructions may be modified to cause the robot 102 to play an alarm warning the dynamic object 128 that the robot 102 is nearby. As another example, the instructions of the robot 102 may be modified to cause the robot 102 to enter the first area 401a and offer to assist the dynamic object 128 with a task.

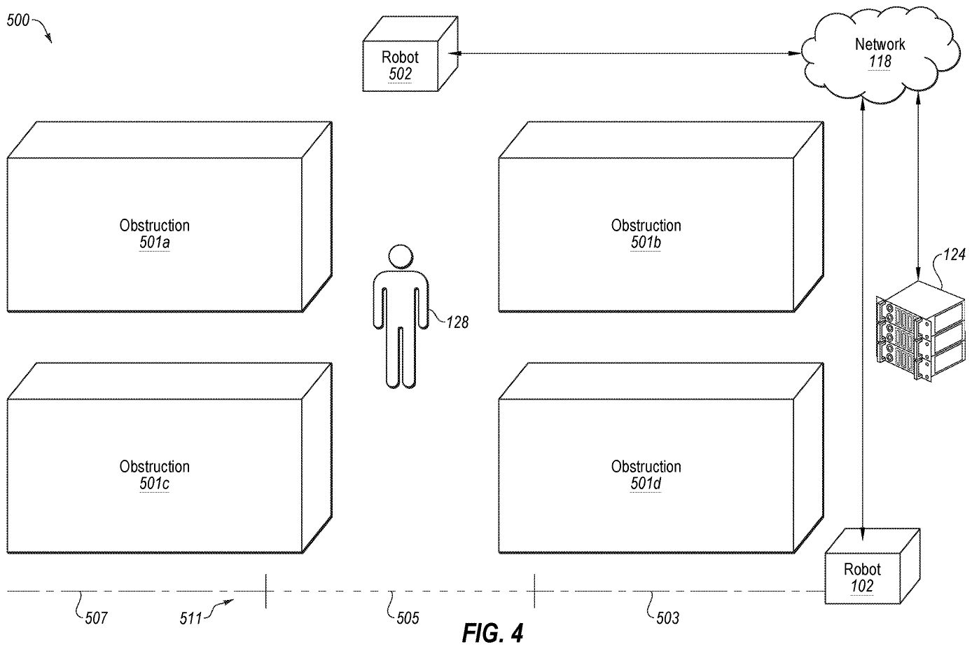

FIG. 4 illustrates a block diagram of another example operational environment 500 in which the robot 102 may operate, in accordance with at least one embodiment described in the present disclosure. The environment 500 may include any location in which the robot 102 may track the dynamic object 128. For example, the environment 500 may include a warehouse, a hospital, a campus, a building, a field, a construction site, and the like.

The environment 500 may include the network 118, the dynamic object 128, the robot 102, another robot 502, or obstructions 501a-d. The another robot 502 may correspond or be similar to the robot 102 of FIG. 1. As shown in FIG. 4, the dynamic object 128 is in a position that is hidden (e.g., occluded) from the view of the robot 102 by the obstruction 501d (e.g., the dynamic object 128 is behind the obstruction 501d relative to the robot 102). However, the dynamic object 128 is not hidden from the view of the robot 502 by the obstructions 501a-d.

The robot 102, the robot 502, or both may capture tracking data indicating a position of the dynamic object 128 in the environment 500. If, as shown in FIG. 4, the dynamic object 128 is hidden from the view of the robot 102, the robot 102 may not be able to perform tasks in consideration of the dynamic object 128 based on the initial, current, or previous instructions. In other words, the robot 102 may not perform tasks in a manner that considers the dynamic object 128 or potential actions of the dynamic object 128 based on the initial, current, or previous instructions. However, the robot 502 may provide the tracking data to the robot 102, the cloud computing system 124, or both so that the instructions of the robot 102 may be updated to perform tasks in consideration of the dynamic object 128.

As depicted in FIG. 4, the robot 102 traverses a path 511 when moving proximate to the obstructions 501c-d. The instructions of the robot 102 may cause the robot 102 to traverse the path 511 at an initial speed that is consistent along the path 511. However, upon the cloud computing system 124 and/or the robot 102 determining that the dynamic object 128 is hidden from the view of the robot 102; proximate to the path 511; or both, the instructions of the robot 102 may be updated to cause the robot 102 to adjust the speed at which it traverses the path 511 when approaching a space between the obstructions 501c-d or the location of the dynamic object 128. For example, the robot 102 may traverse a first portion 503 of the path 511 at the initial speed, traverse a second portion 505 of the path 511 at a reduced speed because the dynamic object 128 is nearby and hidden from the view of the robot 102 at least partially, and traverse a third portion 507 of the path 511 at the initial speed again because the dynamic object 128 is behind the robot 102 and the probability of the robot 102 colliding with the dynamic object 128 is low. Accordingly, the robot 102 may perform the task of traversing the environment 500 in consideration of the dynamic object 128 even when the dynamic object 128 is hidden from the view of the robot 102.

The example of the instructions of the robot 102 being modified to alter the speed at which the robot 102 traverses the path 511 is provided as illustrative. The instructions of the robot 102 may be modified to alter any appropriate task in consideration of the dynamic object 128. For example, the instructions may be modified to cause the robot 102 to play an alarm warning the dynamic object 128 that the robot 102 is nearby. As another example, the instructions of the robot 102 may be modified to cause the robot 102 to stop at the end of the obstruction 501d and offer to assist the dynamic object 128 with a task.

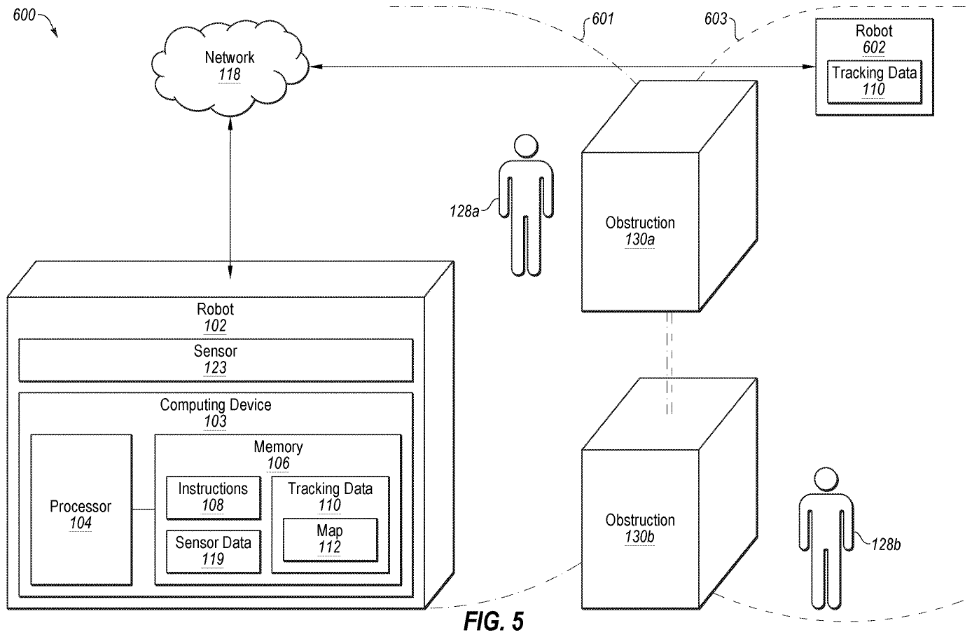

FIG. 5 illustrates a block diagram of an example operational environment 600 in which the robot 102 and a robot 602 may operate, in accordance with at least one embodiment described in the present disclosure. The environment 600 may include any location in which the robot 102 and/or the robot 602 may track dynamic objects 128a-b. For example, the environment 600 may include a warehouse, a hospital, a campus, a building, a field, a construction site, and the like. The robot 602 may correspond or be similar to the robot 102 of FIG. 1.

The robots 102 and 602 may perform various tasks within the environment 600 in accordance with the instructions 108. The robots 102 and 602 may perform the tasks based on actions of and/or in proximity to the dynamic objects 128a-b, static objects (e.g., obstructions 130a-b), or any combination thereof.

The robots 102 and 602 may use the tracking data 110 to track the dynamic objects 128a-b (e.g., movement and/or location of the dynamic objects 128a-b) within the environment 600. Additionally, the robots 102 and 602 may share the tracking data 110 between themselves to track the dynamic objects 128a-b even when the dynamic objects 128a-b are hidden from fields of view 601 or 603 of the robots 102 and 602. An example of the field of view 603 of the robot 602 is shown as a dashed line in FIG. 5 and an example of the field of view 601 of the robot 102 is shown as a dashed and dotted line in FIG. 5.

The robot 102 may capture, generate, or share the tracking data 110 with the robot 602 so that the robot 602 can track the dynamic object 128a even though it is hidden from a view of the robot 602. Additionally, the robot 602 may capture, generate, or share the tracking data 110 with the robot 102 so that the robot 102 can track the dynamic object 128b even though it is hidden from the view of the robot 102.

The robots 102 and 602 may determine the locations of the dynamic objects 128a-b based on the sensor data 119, the tracking data 110, or both and generate the map 112. The map 112 may include markers indicating locations of the dynamic objects, heat markers indicating historical locations of the dynamic objects 128a-b, heat markers indicating likely future locations of the dynamic objects 128a-b, directions the dynamic objects 128a-b are moving, or any other appropriate details regarding the dynamic objects 128a-b. Additionally or alternatively, the robots 102 and 602 may identify potential actions of the dynamic objects 128a-b based on the tracking data 110, a confidence score, or both.

The robots 102 and 602 may update the instructions 108 (e.g., their own instructions) to cause the robots 102 and 602 to operate in consideration of the dynamic objects 128a-b. For example, the robot 102 may update its own instructions 108 based on the map 112, the potential actions of the dynamic objects 128a-b, a confidence score, or any other appropriate piece of information such that the robot 102 performs tasks in consideration of both of the dynamic objects 128a-b despite the dynamic object 128b being hidden from view.

Accordingly, the robots 102 and 602 may share the tracking data 110 to allow each other to operate within the environment 600 while tracking the dynamic objects 128a-b, even when the dynamic objects move within the environment 600 and become hidden from view.

FIG. 6 illustrates an example computing system 300 that may be used for the computing device 103, the cloud computing system 124, the robot 120, the robot 502, or the robot 602 described in the present disclosure. The computing system 300 may be configured to implement or direct one or more operations associated with operations of the computing device 103, the cloud computing system 124, the robot 120, the robot 502, or the robot 602, which may include operation of the computing device 103, the cloud computing system 124, the robot 120, the robot 502, or the robot 602. The computing system 300 may include a processor 302, a memory 304, a data storage 306, and a communication unit 308, which all may be communicatively coupled. In some embodiments, the computing system 300 may be part of any of the systems or devices described in this disclosure. For example, the computing system 300 may be configured to perform one or more of the tasks described above with respect to the computing device 103, the robot 102, the cloud computing system 124, the robot 120, the robot 502, or the robot 602.

The processor 302 may include any computing entity, or processing device including various computer hardware or software modules and may be configured to execute instructions stored on any applicable computer-readable storage media. For example, the processor 302 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that the processor 302 may include any number of processors distributed across any number of networks or physical locations that are configured to perform individually or collectively any number of operations described herein.

In some embodiments, the processor 302 may be configured to interpret and/or execute program instructions and/or process data stored in the memory 304, the data storage 306, or the memory 304 and the data storage 306. In some embodiments, the processor 302 may fetch program instructions from the data storage 306 and load the program instructions in the memory 304. After the program instructions are loaded into memory 304, the processor 302 may execute the program instructions.

For example, in some embodiments, the processor 302 may be configured to interpret and/or execute program instructions and/or process data stored in the memory 304, the data storage 306, or the memory 304 and the data storage 306. The program instruction and/or data may be related to an operator directed autonomous system such that the computing system 300 may perform or direct the performance of the operations associated therewith as directed by the instructions.

The memory 304 and the data storage 306 may include computer-readable storage media or one or more computer-readable storage mediums for carrying or having computer-executable instructions or data structures stored thereon. Such computer-readable storage media may be any available media that may be accessed by a computer, such as the processor 302.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a computer. Combinations of the above may also be included within the scope of computer-readable storage media.

Computer-executable instructions may include, for example, instructions and data configured to cause the processor 302 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F. 3d 1346 (Fed. Cir. 2007). Combinations of the above may also be included within the scope of computer-readable media.

The communication unit 308 may include any component, device, system, or combination thereof that is configured to transmit or receive information over a network. In some embodiments, the communication unit 308 may communicate with other devices at other locations, the same location, or even other components within the same system. For example, the communication unit 308 may include a modem, a network card (wireless or wired), an infrared communication device, a wireless communication device (such as an antenna implementing 4G (LTE), 4.5G (LTE-A), and/or 5G (mmWave) telecommunications), and/or chipset (such as a Bluetooth® device (e.g., Bluetooth 5 (Bluetooth Low Energy)), an 802.6 device (e.g., Metropolitan Area Network (MAN)), a Wi-Fi device (e.g., IEEE 802.11ax, a WiMAX device, cellular communication facilities, etc.), and/or the like. The communication unit 308 may permit data to be exchanged with a network and/or any other devices or systems described in the present disclosure.

Modifications, additions, or omissions may be made to the computing system 300 without departing from the scope of the present disclosure. For example, in some embodiments, the computing system 300 may include any number of other components that may not be explicitly illustrated or described. Further, depending on certain implementations, the computing system 300 may not include one or more of the components illustrated and described.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A computing device for use in a robot, the computing device comprising:
one or more computer readable media configured to store instructions; and
a processor coupled to the computer readable media, the processor configured to execute the instructions to cause or direct the computing device to perform operations, the operations comprising:
obtaining tracking data representative of objects detected by a sensor or another robot within an environment;
detecting a dynamic object in the environment using object detection on the tracking data;
determining the dynamic object is no longer detected using object detection on the tracking data;
identifying an obstruction in the environment using object detection on the tracking data;
identifying a potential action of the dynamic object based on the obstruction and aspects of the dynamic object; and
updating instructions of the robot based on the potential action to cause the robot to perform tasks in consideration of the dynamic object to prevent the robot from colliding with the dynamic object or to cause the robot to assist the dynamic object to complete a task.

2. The computing device of claim 1, wherein the tracking data is obtained from at least one of:
a sensor within the environment;
a cloud computing system;
an entry system associated with the environment;
another robot within the environment; or
a computer vision system of the robot.

3. The computing device of claim 1, wherein:
the tracking data is received from a cloud computing system; and
the tracking data indicates at least one of the dynamic object is hidden from view of the robot, a confidence score of the dynamic object being hidden from view of the robot, or the potential action of the dynamic object.

4. The computing device of claim 1, wherein the operation determining the dynamic object is hidden from view of the robot based on the tracking data comprises identifying a marker in the tracking data as indicating that the dynamic object is hidden from view of the robot.

5. The computing device of claim 1, wherein the tracking data comprises:
object data representative of the dynamic object; and
environmental data representative of static features of the environment.

6. The computing device of claim 1, wherein the operations further comprise, responsive to the robot being in a particular area of the environment, querying a cloud computing system for a likelihood of dynamic objects being in the particular area.

7. The computing device of claim 1, wherein the operation determining the dynamic object is hidden from view of the robot based on the tracking data comprises:
detecting the dynamic object using object detection on a first frame of the tracking data;
determining the dynamic object is no longer detected using object detection on a second frame of the tracking data;
identifying the obstruction using object detection on the tracking data;
determining a confidence score that the dynamic object is behind the obstruction relative to the robot based on at least one of:
aspects of the dynamic object;
a trajectory of movement of the dynamic object in the environment;
an amount of time since the dynamic object was initially detected in the environment; or
expected behavior of the dynamic object, wherein the dynamic object is determined to be hidden from the view of the robot if the confidence score exceeds a threshold value.

8. The computing device of claim 1, wherein:
the tracking data is obtained from a cloud computing system; and
the operation determining the dynamic object is hidden from view of the robot based on the tracking data comprises identifying a marker in the tracking data indicating that the cloud computing system detected the obstruction positioned between the robot and the dynamic object.

9. The computing device of claim 1, wherein the tracking data comprises a map indicating a location of the dynamic object.

10. A computing device comprising:
one or more computer readable media configured to store instructions; and
a processor coupled to the computer readable media, the processor configured to execute the instructions to cause or direct the computing device to perform operations, the operations comprising:
obtaining sensor data representative of an environment;
identifying a dynamic object and a robot within the environment based on the sensor data;
determining locations of the dynamic object and the robot in the environment;
determining the dynamic object is hidden from view of the robot based on the locations of the dynamic object and the robot; and
generating tracking data indicating that the dynamic object is hidden from the view of the robot and that the robot is to update instructions based on the dynamic object being hidden from the view of the robot.

11. The computing device of claim 10, wherein the tracking data indicates at least one of:
a confidence score that the dynamic object is hidden from view of the robot; or
a potential action of the dynamic object, wherein the tracking data indicates that the robot is to update the instructions based on the potential action of the dynamic object.

12. The computing device of claim 10, wherein the sensor data is obtained from at least one of:
a sensor within the environment;
an entry system associated with the environment;
a computer vision system of the robot; or
another robot within the environment.

13. The computing device of claim 10, wherein the operation determining the dynamic object is hidden from view of the robot based on the tracking data comprises identifying a marker in the tracking data as indicating that the dynamic object is hidden from view of the robot.

14. The computing device of claim 10, wherein the operation determining the dynamic object is hidden from the view of the robot comprises:
determining a location of an obstruction using object detection on the tracking data;
determining a confidence score that the obstruction is positioned between the dynamic object and the robot based on at least one of:
aspects of the dynamic object;
a trajectory of movement of the dynamic object in the environment;
an amount of time since the dynamic object was initially detected in the environment; or
expected behavior of the dynamic object, wherein the dynamic object is determined to be hidden from the view of the robot if the confidence score exceeds a threshold value.

15. The computing device of claim 10, wherein:
the dynamic object and the robot are identified using object detection on the sensor data; and
the dynamic object comprises an object that is identified as being able to move within the environment.

16. The computing device of claim 10, wherein the sensor data is received from another robot.

17. A computing device comprising:
one or more computer readable media configured to store instructions; and
a processor coupled to the computer readable media, the processor configured to execute the instructions to cause or direct the computing device to perform operations, the operations comprising:
obtaining sensor data representative of an environment;
determining whether a robot is within the environment;
responsive to the robot being detected within the environment, determining a confidence score that a dynamic object is within the environment based on the sensor data; and
generating tracking data indicating the confidence score and that the robot is to update instructions based on the confidence score.

18. The computing device of claim 17, wherein the confidence score indicates a likelihood that the dynamic object is hidden from view of the robot.

19. The computing device of claim 17, wherein the dynamic object comprises at least one of a human, another robot, a mobile cart, an object being pushed by a human or another robot, an animal, or a mobile object.

20. The computing device of claim 17, wherein the sensor data is received from another robot.
